(19) United States
(12) Patent Application Publication
(10) Pub. No.: US 2025/0196060 A1
(43) Pub. Date: Jun. 19, 2025

(54) APPARATUS AND PROCESS FOR SPLITTING UP SUBSTANCES

(71) Applicant: Stephan Wege, Bannewitz-Cunnersdorf (DE)

(72) Inventor: Stephan Wege, Bannewitz-Cunnersdorf (DE)

(21) Appl. No.: 18/849,035

(22) PCT Filed: Mar. 16, 2023
(86) PCT No.: PCT/DE2023/100202

§ 371 Date: Sep. 20, 2024

(30) Foreign Application Priority Data
Mar. 23, 2022 (DE) 10 2022 106 776.9

(51) Int. Cl. B01D 53/32

(52) U.S. Cl. CPC B01D 53/323; B01D 2255/20707; B01D 2259/10; B01D 2259/818

(57) ABSTRACT

A process reactor (10) for splitting off molecular components of a gaseous substance (46) or mixture of substances in a separation process includes a reaction chamber (12) with a gas inlet (28, 40) and a gas outlet (73). At least one gas supply (32) is provided, which directs the gaseous substance (46) or the gaseous mixture from the gas inlet (40) to a reaction site (21) in the reaction chamber (12). Separating means (53) in the reaction chamber (12) separate molecular components at the reaction site (21). A power supply (50, 58) is provided for the separating means (53). At least one molecule separator (76) separates different molecular components or newly formed molecules from the molecular components.

### CROSS-REFERENCE TO RELATED APPLICATION

This application is a national stage application, filed under 35 U.S.C. § 371, of International Patent Application PCT/DE2023/100202, filed on Mar. 16, 2023, which claims the benefit of German Patent Application DE 10 2022 106 776.9, filed on Mar. 23, 2022.

### TECHNICAL FIELD

The disclosure relates to a process reactor for splitting off molecular components of a gaseous substance or mixture of substances in a separation process. Furthermore, the disclosure relates to a method for splitting off molecular components of a gaseous substance or mixture of substances in a separation process with a process reactor.

### BACKGROUND

Electrolysis is understood as a chemical process in which electrical current induces a redox reaction. It is used, for example, for the extraction of metals or for the production of substances whose extraction would be more expensive or difficult through purely chemical processes. Electrolysis is used, for instance, for the production of hydrogen, aluminum, chlorine, and sodium hydroxide. The splitting of water into hydrogen and oxygen is becoming increasingly important due to the energy transition.

To produce hydrogen (H₂) and oxygen (O₂) from water (H₂O), the current state of the art often employs electrolysis. In this process, electrodes connected to a direct current source are immersed in the water. In simple terms, oxygen molecules are formed at the cathode, and hydrogen molecules at the anode. In this electrolytic process, electrical energy is converted into chemical energy, which can then be easily stored.

Electrolysis is an extremely simple method for producing hydrogen, which is why it is used in many technical fields. Hydrogen is also produced in other processes where water is split into hydrogen and oxygen using high-frequency electromagnetic fields combined with a plasma discharge. Especially in the context of the energy transition, hydrogen is seen as a promising energy carrier that can be easily stored and transported and produced by wind or solar energy. Hydrogen can then be used as a replacement for fossil fuels.

Although electrolysis is a very simple method, a relatively large amount of energy is still required to split water into its components.

For example, DE 10 2014 010 359 A1 describes a system for the production of hydrogen using electrolysis. The system is powered by electricity drawn from the power grid to perform electrolysis, and it includes at least two electrolysis units whose electrical supply can be independently switched on and off.

DE 10 2014 010 813 A1 also describes an electrolysis device. In this case, a frame for such an electrolysis device is described. The electrolysis device comprises a receiving space for one or more electrolysis cell components, surrounded by an inner edge, an outer edge, and a frame structure extending from the inner edge to the outer edge, formed in one piece from a structural material. Furthermore, the frame structure incorporates a fluid conduit for the fluids to be supplied and removed during electrolysis. Additionally, an electrolysis cell module, as well as an electrolyzer of the stack type constructed from multiple electrolysis cell modules, is equipped with such a frame, particularly for the production of hydrogen.

DE 10 2019 003 980 A1 also describes the production of hydrogen using the electrolysis process. As a source of energy, hydrogen is becoming increasingly important. However, the high costs of production and the limited transportation options for hydrogen at pressures above 700 bar present significant challenges. One potential solution is the use of solar energy to directly produce hydrogen at the point of use.

DE 10 2011 081 915 B4 discloses a method and a device for splitting water, by using electromagnetic fields in the high-frequency range in combination with an electrical plasma discharge in the gas phase and/or the boundary region between the water and gas phases. The method and the device can be used in particular for the formation of hydrogen (H₂) from water (H₂O), for the formation of reactive oxidizing and/or reducing species, for the degradation of pollutants, for the hygienization of water and/or for the desalination of seawater or other saline water, preferably in conjunction with other aforementioned applications.

EP 3 919 438 A1 relates to a process and a device for the thermal decomposition of a starting material containing carbon hydride. In the process, a non-thermal microwave plasma is generated in a microwave plasma device from at least a portion of the starting material present in gaseous or vapor form or brought into gaseous or vapor form by means of microwave radiation acting on the starting material. The starting material is thereby split into a carbon portion and a hydrogen portion. Further, the carbon and hydrogen fractions are separated from each other in a separation process outside the microwave plasma device.

The known devices and methods have the disadvantage that relatively large amounts of energy are required to produce hydrogen (H₂) for technical applications. The efficiency of the known devices and methods is insufficient or needs improvement.

### SUMMARY

An object of the disclosure is to overcome the disadvantages of the prior art and to split molecules, particularly water molecules, as energy-efficiently as possible, as is done, for example, in electrolysis.

This object is achieved by a process reactor for splitting off molecular components of a gaseous substance or mixture of substances in a separation process. The process reactor includes:
a) a reaction chamber with a gas inlet and a gas outlet;
b) at least one gas supply, which directs the gaseous substance or the gaseous mixture of substances from the gas inlet to a reaction site in the reaction chamber;
c) separating means in the reaction chamber for separating molecular components at the reaction site;
d) a power supply for the separating means; and
e) at least one molecule separator, which separates different molecular components or newly formed molecules from the molecular components.
f) The separating means comprise at least two spaced electrodes, which are subjected to an RF frequency to generate a plasma from a plasma gas, and
g) a pump is provided for operating the reaction chamber under vacuum conditions.

The disclosure is based on the principle of breaking down a substance or mixture of substances through plasma and separating the cleavage products. Working at underpressure allows the substance or mixture of substances to be particularly efficiently split by the plasma. Plasma technology is often used in semiconductor manufacturing. This involves the use of systems that use gases to etch or deposit molecules onto the semiconductor being processed. During these processes, hydrogen is also produced. Surprisingly, it has been shown that plasma technology can also be generally applied to the production of hydrogen. In principle, other gaseous substances can also be split using plasma technology. The substance to be processed is introduced into the plasma as evenly as possible.

The plasma is generated from a plasma gas, such as the noble gas argon (Ar), which is ignited by an electric RF alternating field. The plasma gas can also be a gas mixture, for example, consisting of argon (Ar) and xenon (Xe). The component proportions of the gas mixture can be adjusted to suit the requirements of the generated plasma and the molecule to be split. The electric RF alternating field is generated between two electrodes, into which the plasma gas is introduced. By separating the cleavage products from the plasma gas, the desired cleavage product, such as hydrogen (H₂), is obtained. The separation process can be scaled very easily, depending primarily on the size of the reaction chamber, the electrodes, and, consequently, the plasma.

An advantageous embodiment of the process reactor for splitting off molecular components of a gaseous substance or mixture of substances in a separation process is that the at least two spaced electrodes are formed from parallel plates. This design serves to configure the electrode surface in such a way that a correspondingly large plasma can form, where the separation process takes place. The larger the plasma, the more separation processes occur.

A further advantageous embodiment of the process reactor is that the molecule separator is arranged downstream of the pump. In this way, the cleavage products are first evacuated from the process chamber and then separated. The cleavage products and the plasma gas can then be more easily directed to their intended use. For example, the plasma gas can be reused in the reaction chamber to generate plasma.

A preferred and advantageous embodiment of the process reactor is also that at least one gas supply with at least one outlet opening uniformly directs the gaseous substance or the gaseous mixture of substances between the electrodes to the reaction site in the plasma. This measure ensures that the gaseous substance or gaseous mixture of substances are released only at the reaction site, preventing unwanted deposition or other adverse effects.

An advantageous embodiment of the reactor is achieved by forming at least one outlet opening as a Laval nozzle. One or more simple outlet openings may not be able to uniformly deliver the gas to the reaction site in the plasma. A Laval nozzle is a flow organ in which the cross-section first narrows and then widens, with the transition from one part to the other being continuous. The cross-sectional area is typically circular or elliptical at every location. Due to their shape, Laval nozzles can direct gas into the plasma at the reaction site extremely uniformly and widely. This uniformity remains even at very high gas speeds or pressures. For instance, gas speeds of 300 m/s and more can be achieved, allowing large amounts of gas to be processed through the plasma within a given time. In this way, a large number of molecules can be split in the plasma.

Another advantageous embodiment of the process reactor is that pulse means are provided, which allow the gaseous substance or mixture of substances to exit pulsed from at least one outlet opening. The pulsating flow of the gaseous substance or mixture of substances increases the particle density per unit volume, significantly enhancing the likelihood of molecule splitting in the plasma.

In another advantageous embodiment of the process reactor, the gas supply at least partially surrounds the reaction site, with at least one outlet opening directed toward the reaction site. This measure serves the purpose of ensuring that the gas supply feeds the gas to be processed into the plasma for the cleavage/separation from as many sides as possible. For this purpose, the gas supply can have an outlet body at its end, which then contains the outlet openings or the lava nozzles. This outlet body can be ring-shaped or U-shaped.

Furthermore, an advantageous embodiment of the process reactor includes a heating device upstream the gas inlet, which converts a liquid phase of a substance and/or of substances into a gaseous phase. For example, liquid water (H₂O) can easily be converted into vapor by heating. The vapor or gas can then be directed to the reaction site via the gas supply.

The efficiency of the separation process can be further increased if the process reactor is equipped with means for generating a magnetic field in the reaction chamber. The magnetic field influences the reaction between the plasma and the gaseous substance to be split.

A particularly advantageous embodiment of the process reactor for splitting off molecular components of a gaseous substance or mixture of substances in a separation process is achieved by having the means for generating a magnetic field include at least one electrically operated magnetic coil. The magnetic coil can be easily tuned to the separation process in the plasma by varying the electric current flowing through it.

In another advantageous embodiment of the process reactor, an alternating voltage generator is provided for the at least one magnetic coil, which generates an alternating magnetic field. In this variant, the alternating magnetic field improves the efficiency of the production rate of the cleavage products. The alternating magnetic field creates additional interactions between the reactants, positively influencing the separation processes.

A further preferred embodiment of the process reactor is also that the magnetic field is arranged perpendicular to the electric field of the electrodes. This measure also increases the production rate of the cleavage products.

In a special variant of the process reactor, pairs of electrodes are formed, which are arranged in series or stacked, with plasma being generated between each pair of electrodes. In a single electrode pair, the production rate of the cleavage products is limited by the size of the plasma and the dimensions of the electrodes. By stacking the electrode pairs, the production of the cleavage products can be significantly increased. This arrangement allows the electrode pair surfaces and the plasma volume to be greatly expanded within the reaction chamber, enabling cost-effective splitting on a larger scale since only one reaction chamber is needed.

Another advantageous embodiment of the process reactor is that an insulator separates the electrode pairs. The insulator ensures that the individual electrode pairs, between which the plasma is located, do not undesirably influence each other. This shields the electrode pairs from one another.

In a preferred variant of the process reactor, the insulator includes an iron core and/or a permanent magnet. The iron core serves as a simple amplifier for the magnetic field, enhancing the efficiency of the magnetic field on the plasma and thus the separation reactions with little effort. A permanent magnet can be used, for example, when no external magnetic field is applied.

Furthermore, in a very advantageous and preferred embodiment of the process reactor, a catalyst is provided to accelerate the separation process. The catalyst accelerates the reactions, reducing the energy required to separate the substance or mixture of substances. Thus, a significant efficiency increase is achieved with the catalyst. The light from the plasma, in conjunction with the catalyst, can additionally amplify the separation process. The photons generated during plasma production can now carry enough energy to enable the splitting of the molecule in conjunction with the catalyst. The catalyst can also be introduced into the reaction chamber as a gas at the reaction site.

In an advantageous embodiment of the process reactor, the catalyst contains titanium oxide. Titanium oxide significantly accelerates the splitting of a substance or mixture of substances, making it particularly well-suited as a catalyst. Here too, the light from the plasma, in conjunction with the catalyst, further amplifies the splitting process.

A special variant of the process reactor is that the electrodes and/or walls of the reaction chamber are coated with the catalyst. To avoid introducing the catalyst into the reaction chamber with the substance or mixture of substances to be split, the electrodes and/or walls of the reaction chamber are coated with the catalyst. The coating can even be applied during operation, such as by depositing titanium oxide on the walls or electrodes.

The object is also solved by a method for separating molecular components of a gaseous substance or mixture of substances in a separation process using a process reactor with the features mentioned above, with the following method steps:
a) generating a vacuum in the reaction chamber using the pump,
b) generating plasma from the plasma gas between the electrodes, which are subjected to an RF frequency,
c) introducing the gas to be separated or gas mixture through the gas inlet of the process chamber,
d) directing the gas or gas mixture through the gas supply between the electrodes,
e) separating the different molecular components or newly formed molecules from the molecular components using a molecule separator.

The method is based on the principle of breaking down a substance or mixture of substances through plasma and separating the cleavage products. Working at underpressure allows the substance or mixture of substances to be particularly efficiently split by the plasma. During these processes, hydrogen is also produced. Surprisingly, it has been shown that plasma technology can also be generally applied to the production of hydrogen. In principle, other gaseous substances can also be split using plasma technology. The substance to be processed is introduced into the plasma as evenly as possible. The plasma is generated from a plasma gas, such as the noble gas argon (Ar), which is ignited by an electric RF alternating field. The electric RF alternating field is generated between two electrodes, into which the plasma gas is introduced. By separating the cleavage products from the plasma gas, the desired cleavage product, such as hydrogen (H₂), is obtained.

Further embodiments and advantages are evident from the subject matter of the dependent claims and the drawings with the accompanying descriptions. Exemplary embodiments are further explained below with reference to the attached drawings. In this context, spatially relative terms such as “below,” “under,” “lower,” “above,” “upper,” and the like may be used in the present text to simplify the description and to describe the relationship of an element or structural element to one or more other elements or structural elements as illustrated in the figures. The spatially relative terms are intended to encompass other orientations of the device during use or operation, in addition to the orientation shown in the figures. The device may also be otherwise oriented (rotated 90 degrees or otherwise oriented), and the spatially relative descriptors used in the present text can be interpreted accordingly.

The invention is not intended to be limited solely to these listed exemplary embodiments. They merely serve to further explain the invention. Additionally, the content of the cited documents is made part of the disclosure of the present application.

### BRIEF DESCRIPTION OF THE DRAWINGS

FIG. 1 shows, in a first exemplary embodiment, a schematic diagram of a process reactor for separating molecular components of a gaseous substance or mixture of substances in a separation process, with a pair of parallel electrode plates in a longitudinal section.

FIG. 2 shows, in a schematic diagram, a cross-section through a process reactor according to FIG. 1.

FIG. 3 shows, in a second exemplary embodiment, a schematic diagram of a process reactor for separating molecular components of a gaseous substance or mixture of substances in a separation process, with a stack of pairs of parallel electrode plates in a longitudinal section.

### DETAILED DESCRIPTION

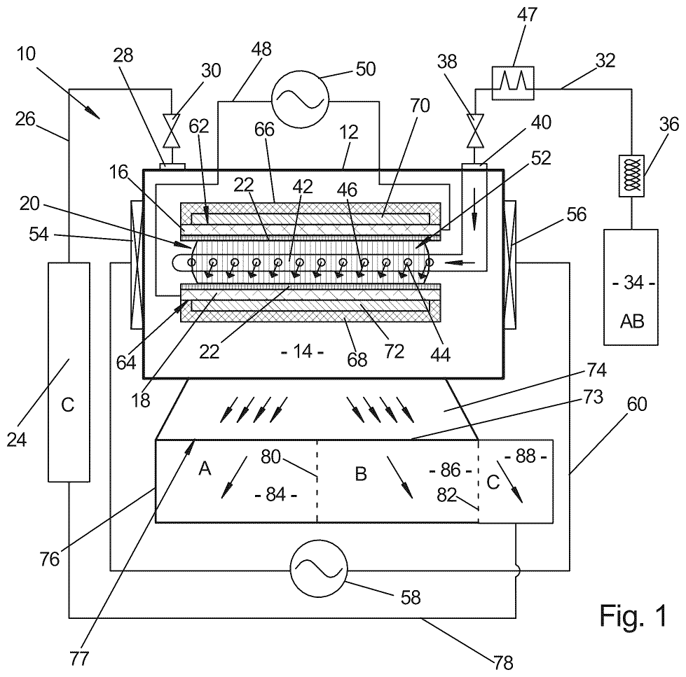

FIG. 1 shows a schematic longitudinal section of a first embodiment of a process reactor 10. The process reactor 10 comprises a reaction chamber 12 with walls 13, in which molecular components of a gaseous substance or mixture of substances are separated in a separation process. For example, in such a separation process, water molecules are split into their atomic elements, oxygen and hydrogen.

In an interior space 14 of the reaction chamber 12, a pair of parallel and spaced electrode plates 16, 18 are arranged, forming a gap 20. The electrode plates 16, 18, as well as the walls 13 of the interior space 14 of the reaction chamber 12, are coated with a suitable catalyst 22 for the reaction. In this embodiment, the catalyst layer 22 is titanium oxide. The catalyst layer can be applied during operation. A plasma gas, denoted by “C” here, preferably a noble gas such as argon (Ar), is supplied from a plasma gas container 24 via a gas line 26 to an inlet 28 for the plasma gas C into the reaction chamber 12. The plasma gas C may also be a gas mixture, such as a combination of argon (Ar) and xenon (Xe). The component proportions of the gas mixture can be adjusted to suit the requirements of the generated plasma and the molecule to be split. The amount of plasma gas introduced is regulated by a first controllable valve 30.

A gaseous substance, denoted by “AB” here, or possibly a substance mixture, is introduced via a gas supply 32 into the reaction chamber 12 into the gap 20 for the separation of molecular components. The substance AB or the mixture to be processed is contained in a container 34. The substance may also be present in liquid form, and through simple heating by a heating device 36, the substance or mixture can be converted into a more easily processed gaseous phase before entering the reaction chamber 12.

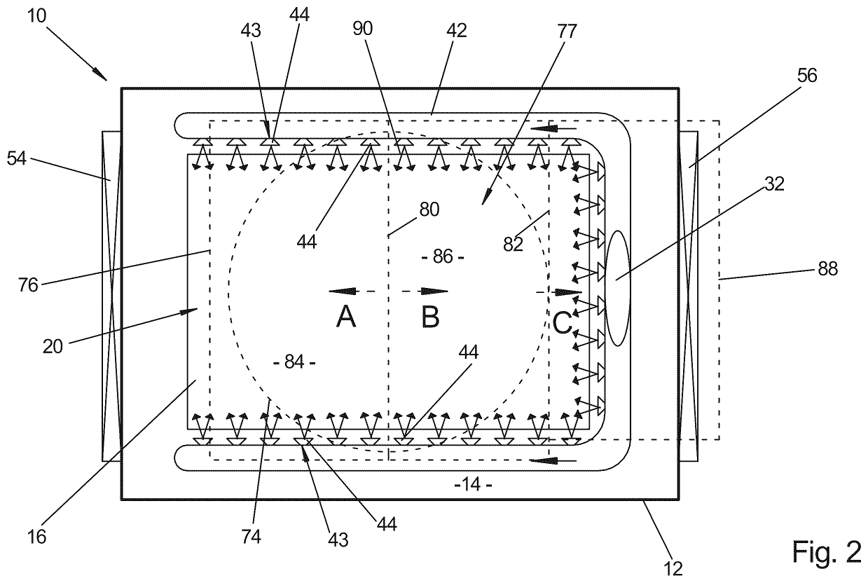

A second controllable valve 38 regulates the gas amount of the substance AB or mixture to be processed, which is introduced into the interior 14 of the reaction chamber 12 through another inlet 40. The gas supply 32 ends in an outlet body 42, which in this embodiment surrounds the gap 20 between the electrode plates 16, 18 in a U-shape (see also FIG. 2). The gap 20 forms a reaction site 21 where the main separation processes occur.

The outlet body 42 is tubular and has outlet openings 43 directed towards the gap 20 formed by the electrode plates 16, 18. In this embodiment, the outlet openings 43 are designed as Laval nozzles 44. The gas AB to be processed exits the Laval nozzles 44 of the outlet body 42 and flows between the electrode plates 16, 18, as indicated by arrows 46. Using pulse means 47, the gaseous substance 46 or the mixture exits from the outlet openings 43 in pulses, with gas amounts exiting intermittently from the openings 43. The pulse duration is, for example, in the range of 10 ms to 50 ms.

The electrode plates 16, 18 are supplied with a high-frequency alternating voltage via electrical lines 48. The RF alternating voltage is generated by an alternating voltage generator 50. In this embodiment, the RF alternating voltage frequency is in the range of 60 MHz. The high-frequency RF alternating voltage generates an electric alternating field, which energetically interacts with the plasma gas and ignites it. Plasma 52 is generated between the electrode plates 16, 18. The separating means 53 include the electrode plates 16, 18 and the plasma 52, which splits the gas AB into the cleavage products A and B.

The gas AB exiting the Laval nozzles 44 of the outlet body 42 encounters the plasma 52, which ideally splits the incoming gas AB into the molecular components A and B. Since the plasma 52 is generated from a noble gas, the plasma gas C itself does not react with the separated components A and B of the processed gas AB.

The interaction of the plasma 52 with the gas AB is further enhanced by a magnetic alternating field. For this purpose, coils 54, 56 are arranged laterally on the reaction chamber 12 to generate a magnetic alternating field. In this embodiment, the magnetic alternating field is oriented substantially perpendicular to the electric alternating field between the electrode plates 16, 18. The coils 54, 56 are also supplied with RF alternating voltage from another alternating voltage generator 58 via electrical lines 60. On their respective rear sides 62, 64, the electrode plates 16, 18 have electrical insulators 66, 68 as shields. These insulators 66, 68 contain iron cores 70, 72 that enhance the magnetic alternating field generated by the coils 54, 56.

In addition to the plasma gas C, the cleavage products, namely the molecular components A and B, which originate from the gas AB, are evacuated from the reaction chamber 12 through a lower gas outlet 73 by a pump 74. The pump 74 is tightly flanged to the gas outlet 73 of the reaction chamber 12. In this embodiment, the pump 74 maintains a vacuum of typically 200 mTorr in the reaction chamber 10 during operation of the process reactor 10.

The gas mixture A, B, C, that is, the different cleavage products A and B, as well as the plasma gas C, are fed to a molecule separator 76. The molecule separator 76 is mounted downstream of the pump 74 at the outlet 77 of the pump 74. The molecule separator 76 separates the components A, B, C of the gas mixture from one another. The plasma gas C is then returned to the plasma gas container 24 via the gas line 78. The molecule separator 76 may operate, for example, with semipermeable membranes 80, 82. Only molecules with a certain diameter pass through the respective semipermeable membranes 80, 82 into separate chambers 84, 86, 88 of the separator 76. From there, the separated gases A, B, C can be directed to their respective uses.

In FIG. 2, a horizontal sectional view of the process reactor 10 of FIG. 1 is shown as a simplified schematic representation. Where the figures correspond, the same reference numerals are used. In the interior 14 of the reaction chamber 12, the upper electrode plate 16 is visible. The electrode plate 16 is surrounded on three sides by the U-shaped outlet body 42.

The gas supply 32 ends in the outlet body 42. The outlet body 42 contains numerous outlet openings 43. The outlet openings 43 are designed as Laval nozzles 44, which are evenly directed inward towards the gap 20. This ensures optimal distribution of the processed gas 46 in the gap 20 between the electrode plates 16, 18. Even distribution of the processed gas promotes continuous interaction with the plasma 52 and efficient splitting of the processed gas 46. Arrows 90 indicate how the gas 46 flows through the Laval nozzles 44 from the outlet body 42. The pulse means 47 introduce the pulsed gaseous substance 46 or mixture into the reaction site 21.

The coils 54, 56 are mounted laterally on the reaction chamber 12 to generate the magnetic alternating field. This magnetic alternating field is arranged perpendicular to the electric alternating field formed between the electrode plates 16, 18. The electric and magnetic alternating fields are tuned to work together.

Dashed lines show the molecule separator 76 and the pump 74 in this illustration. The pump 74 evacuates the reaction chamber 12 and maintains a vacuum of about 200 mTorr. The molecule separator 76 contains separate chambers 84, 86, and 88, which are separated by semipermeable membranes 80, 82. These semipermeable membranes are designed to only allow molecules of certain diameters to pass through. This allows for the separation of the cleavage products A, B, and the plasma gas C. The gases A, B, and C are then available in their respective chambers 84, 86, 88 for further use.

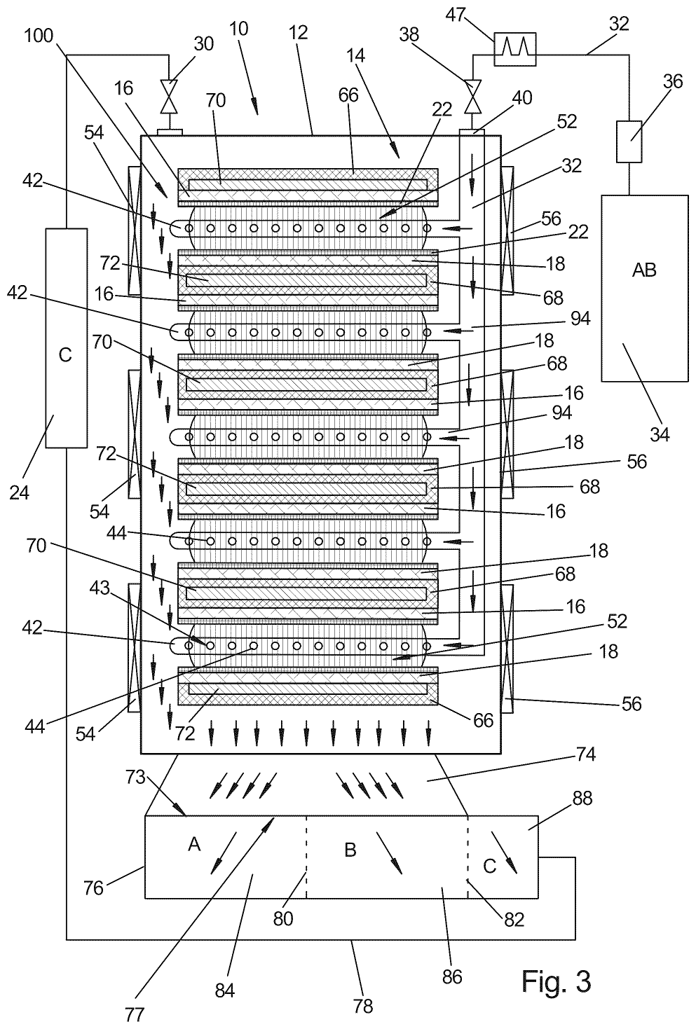

FIG. 3 shows another embodiment of the process reactor 10 for separating molecular components of a gaseous substance or mixture in a separation process. The process reactor 10 is shown as a schematic representation in a longitudinal section. Where the components in this figure correspond to those in the previous figures, the same reference numerals are used. Instead of a single pair of electrode plates 16, 18, multiple pairs are arranged in a stack 92, either one behind the other or on top of each other.

In the interior 14 of the reaction chamber 12, the stack 92 is formed by pairs of parallel electrode plates 16, 18. Each pair of electrode plates 16, 18 has a gap 20 that forms the reaction site 21. The electrode plates 16, 18, as well as the interior 14 of the reaction chamber 12, are coated with the catalyst 22 for the reaction. In this embodiment, the catalyst layer 22 is titanium oxide. The catalyst layer 22 can be applied during the operation of the process reactor through appropriate deposition. The plasma gas C is also a noble gas, such as argon (Ar). Alternatively, a noble gas mixture composed of different noble gases could be used as a plasma gas mixture. The plasma gas C is supplied from the plasma gas container 24 via the gas line 26 through the inlet 28 into the reaction chamber 12. The required amount of plasma gas is regulated by a first controllable valve 30.

The gaseous substance AB is introduced via the gas supply 32 into the reaction chamber 12 to the gaps 20, similar to FIG. 1. The gas supply 32 includes branches 94, which each lead to the outlet bodies 42. The substance AB to be processed is initially contained in the container 34. The substance AB may also be in liquid form, such as water (H₂O), and the heating device 36 generates gas from it as needed before it enters the reaction chamber 12.

The second valve 38 controls the necessary amount of gas AB, which is introduced into the interior 14 of the reaction chamber 12 through the inlet 40. Each gap 20 between the pairs of electrode plates 16, 18 is assigned its own outlet body 42. These outlet bodies 42 surround the space between the electrode plates 16, 18 in a U-shape, as shown in FIG. 2. Each outlet body 42 is tubular and has outlet openings 43. The outlet openings 43 are designed as Laval nozzles 44, which are each directed towards their assigned gap 20. In operation, the gas AB exits the Laval nozzles 44 of the outlet bodies 42 and is pulsed between the electrode plates 16, 18 by the pulse means 47.

The electrode plates 16, 18 are supplied with a high-frequency alternating voltage. The RF alternating voltage is generated by the alternating voltage generator 50, not shown in this figure. The frequency of the RF alternating voltage is again in the range of 60 MHz. The RF alternating voltage applied to the stack 92 is synchronized across the electrode plates 16, 18. The high-frequency alternating voltage generates an electric alternating field in all the gaps 20 of the stack 92, which energetically interacts with the plasma gas and ignites it. Plasma 52 is generated between the electrode plates 16, 18.

The gas AB exiting the Laval nozzles 44 of the outlet bodies 42 encounters the plasma 52, which ideally splits the incoming gas AB into the molecular components A and B. Since the plasma 52 is generated from a noble gas, the plasma gas C itself does not react with the separated components A and B of the processed gas AB.

The interaction of the plasma 52 with the gas AB is further enhanced by the magnetic alternating field generated by the coils 54, 56 mounted laterally on the reaction chamber 12. The magnetic alternating field is arranged perpendicular to the electric alternating field between the electrode plates 16, 18. The coils 54, 56 are also supplied with RF alternating voltage from another alternating voltage generator 58, not shown.

On their respective rear sides 62, 64, the electrode plates 16, 18 have electrical insulators 66, 68 as shields. The insulators 66, 68 prevent the pairs of electrode plates 16, 18 from influencing each other. The insulators 66, 68 also contain iron cores 70, 72, which enhance the magnetic alternating field generated by the coils 54, 56.

Both the plasma gas C and the cleavage products, the molecular components A and B, are evacuated from the reaction chamber 12 through the lower gas outlet 73 in the direction of arrows 96 by the pump 74. The pump 74 is tightly flanged to the gas outlet 73 of the reaction chamber 12. During operation, the pump 74 maintains a vacuum of typically 200 m Torr in the reaction chamber 10.

The gas mixture A, B, C, that is, the different cleavage products A and B, as well as the plasma gas C, are fed to the molecule separator 76. The molecule separator 76 is mounted downstream of the pump 74. The molecule separator 76 is tightly mounted at the outlet 77 of the pump 74. The molecule separator 76 separates the components A, B, and C of the gas mixture from one another. The plasma gas C is then returned to the plasma gas container 24 via the gas line 78. The molecule separator 76 operates, for example, with semipermeable membranes 80, 82. Gas centrifuges can also be used as the molecule separator 76. Only molecules with a specific diameter pass through the respective semipermeable membranes 80, 82 into the separate chambers 84, 86, 88 of the molecule separator 76.

### REFERENCE NUMERAL LIST

10 Process reactor
12 Reaction chamber
13 Walls
14 Interior space
16, 18 Electrode plates
20 Gap
21 Reaction site
22 Catalyst layer
24 Plasma gas container
26 Gas line
28 Inlet for plasma gas
30 First controllable valve
32 Gas supply
34 Container
36 Heating device
38 Second controllable valve
40 Inlet for gas
42 Outlet body
43 Outlet openings
44 Laval nozzles
46 Gas
47 Pulse means
48 Electrical lines
50 Alternating voltage generator
52 Plasma
53 Separating means
54, 56 Coils
58 Alternating voltage generator
60 Electrical lines
62, 64 Rear sides of electrodes
66, 68 Insulator
70, 72 Iron cores
73 Gas outlet
74 Pump
76 Molecule separator
77 Pump outlet
78 Gas lines
80, 82 Semipermeable membranes
84, 86, 88 Separate chambers
90 Arrows
92 Stack
94 Branch
96 Arrows

1-19. (canceled)

20. A process reactor (10) for separating molecular components of a gaseous substance (46) or mixture of substances in a separation process, comprising:
a reaction chamber (12) with a gas inlet (28, 40) and a gas outlet (73);
a gas supply (32), which directs the gaseous substance (46) or mixture of substances from the gas inlet (40) to a reaction site (21) in the reaction chamber (12);
separating means (53) in the reaction chamber (12) for separating the molecular components at the reaction site (21);
a power supply (50, 58) for the separating means (53);
at least one molecule separator (76), which separates different ones of the molecular components or molecules that are newly formed from the molecular components;
wherein the separating means (53) comprise at least two spaced electrodes (16, 18),
wherein the at least two spaced electrodes (16, 18) are subjected to an RF frequency to generate a plasma (52) from a plasma gas, and
wherein a pump (74) is provided for operating the reaction chamber (12) under vacuum.

21. The process reactor (10) according to claim 20,
wherein the at least two spaced electrodes (16, 18) are formed from parallel plates.

22. The process reactor (10) according to claim 20,
wherein the molecule separator (76) is arranged downstream of the pump (74).

23. The process reactor (10) according to claim 20,
wherein the gas supply (32, 42) has at least one outlet opening (43), and
wherein the at least one outlet opening (43) uniformly directs the gaseous substance (46) or mixture of substances between the at least two spaced electrodes (16, 18) to the reaction site (21) in the plasma (52).

24. The process reactor (10) according to claim 23,
wherein the at least one outlet opening (43) is formed as a Laval nozzle (44).

25. The process reactor (10) according to claim 20,
further comprising pulse means (47),
wherein the pulse means (47) cause the gaseous substance (46) or mixture of substances to exit pulsed from at least one outlet opening (43).

26. The process reactor (10) according to claim 25,
wherein the gas supply (32) at least partially surrounds the reaction site (21), and
wherein the at least one outlet opening (43) is directed at the reaction site (21).

27. The process reactor (10) according to claim 20,
further comprising a heating device (36) upstream of the gas inlet (40),
wherein the heating device (36) converts a liquid phase of the substance (46) or mixture of substances into a gaseous phase.

28. The process reactor (10) according to claim 20,
further comprising means (54, 56, 70, 72) for generating a magnetic field in the reaction chamber (12).

29. The process reactor (10) according to claim 28,
wherein the means (54, 56, 70, 72) for generating the magnetic field include at least one electrically operated magnetic coil (54, 56).

30. The process reactor (10) according to claim 29,
further comprising an alternating voltage generator (58) for the at least one electrically operated magnetic coil (54, 56) for generating an alternating magnetic field.

31. The process reactor (10) according to claim 30,
wherein the magnetic field is arranged perpendicular to an electric field of the at least two spaced electrodes (16, 18).

32. The process reactor (10) according to claim 20,
wherein the at least two spaced electrodes (16, 18) include pairs of electrodes (16, 18),
wherein the pairs of electrodes (16, 18) are arranged in series or stacked, with the plasma (52) being generated between each pair of the pairs of electrodes (16, 18).

33. The process reactor (10) according to claim 32,
wherein an insulator (66, 68) separates the pairs of electrodes.

34. The process reactor (10) according to claim 33,
wherein the insulator (66, 68) includes an iron core (70, 72) and/or a permanent magnet.

35. The process reactor (10) according to claim 20,
further comprising a catalyst (22) for accelerating the separation process.

36. The process reactor (10) according to claim 35,
wherein the catalyst (22) contains titanium oxide.

37. The process reactor (10) according to claim 35,
wherein the at least two spaced electrodes (16, 18) and/or walls (13) of the reaction chamber (12) are coated with the catalyst (22).

38. A method, comprising:
providing the process reactor (10) according to claim 20;
generating the vacuum in the reaction chamber (12) with the pump (74);
generating the plasma (52) from the plasma gas between the electrodes (16, 18), which are subjected to an RF alternating voltage;
introducing the gaseous substance (46) or mixture of substances to be separated through the gas inlet (40) of the reaction chamber (12);
directing the gaseous substance (46) or mixture of substances through the gas supply (32) between the electrodes (16, 18); and
separating the different ones of the molecular components or the molecules that are newly formed from the molecular components using the molecule separator (76).
